(19) United States
(12) Patent Application Publication
(10) Pub. No.: US 2026/0186163 A1
(43) Pub. Date: Jul. 2, 2026

(54) WIDEBAND DETECTION MODE RFID READER

(71) Applicant: Tempo Communications, Inc., Vista, CA (US)

(72) Inventors: Istvan Ther, Vista, CA (US); Mihaly Mozsary, Vista, CA (US); Curtis Clifford Taylor, Vista, CA (US)

(21) Appl. No.: 19/429,378

(22) Filed: Dec. 22, 2025

Related U.S. Application Data
(60) Provisional application No. 63/738,870, filed on Dec. 26, 2024.

(51) Int. Cl. G01V 3/165; G01V 3/10; G01V 3/36; G01V 15/00

(52) U.S. Cl. CPC G01V 3/165; G01V 3/10; G01V 3/36; G01V 15/00

(57) ABSTRACT

A wide band detection mode RFID reader capable of covering all operating frequencies of an LF RFID tag. The reader device first detects a marker ID tag, identifies operating frequency of the detected ID tag, tunes the reader devices to the tag natural frequency of the detected ID tag, then reads the data stored in the detected ID tag. Matching the resonance frequency of the reader device to the detected ID tag based on instantaneous measurement ensures well coupled communication. The wide band operation of the reader device offers the possibility of building multi-frequency RFID systems that carry multiple new opportunities in the field.

### CROSS-REFERENCE TO RELATED APPLICATIONS

This application claims the benefit of U.S. Provisional Application No. 63/738,870, filed on Dec. 26, 2024. The disclosure of the above application is incorporated herein by reference in its entirety.

### FIELD

The present teachings relate to buried marker locator systems or devices for locating underground (i.e., buried) markers, and more particularly to a buried marker locator system or device that tunes a resonant frequency of a transmit signal of the locator to the operational resonant frequency of the marker.

### BACKGROUND

The statements in this section merely provide background information related to the present disclosure and may not constitute prior art.

Today many companies, e.g., utility companies such as telecommunication companies, electrical utility companies, gas companies, water companies, sewer companies, etc., bury their respective products, or structures, underground. Locating such structures is useful when repairs to the structures are needed and to avoid hitting the structures during subsequent excavation. However, often such structures are made from non-metallic components such as fiber optic cable which can make subsequent identification of the location of such buried structures difficult. Therefore, to make locating these underground structures easier, companies and utilities often use underground passive electromagnetic markers that can be buried adjacent and in close proximity of the structures (e.g., 1 to 12 inches) as the structures are being installed and buried. These markers can subsequently be located, and hence the location of the structures can subsequently be identified, with a specialized locating device (referred to as a locator device) from above the ground.

There are several known variations of such underground markers. Typically, such markers operate at various standard radio frequencies such that markers of a certain frequency will be buried with specific structures so that the location of specific structures can be easily and readily identified. Typical radio frequency marker and locator systems consist of a passive module called the marker comprising an ID tag (e.g., a transponder and corresponding integrated circuit (IC) referred to as the marker IC) and an active module called the locator or reader device comprising a transmit and receive antenna and corresponding integrated circuit (IC), referred to as the locator IC. The locator and marker connect via inductive coupling (e.g., via resonant inductive coupling) and bidirectionally communicate, via the inductive coupling, to receive marker data stored in marker IC. More particularly, the basic operation is as follows: a transmitter or signal generator of the locator IC emits an excitation signal strong enough to energize a coil of marker IC. The energized marker IC then generates and modulates a magnetic field, whereafter the modulated signal is received and demodulated on by the locator IC. The marker IC communicates the marker data to the locator IC via the modulated signal.

Efficient data transfer in such systems can be realized if the frequency of the excitation signal (e.g., the excitation frequency) and the resonant frequency of the marker IC match, and if antennas of the locator IC resonator and the marker IC resonator have a high quality factor (Q factor). However, these criterion in practice are very challenged by manufacturing tolerances and environmental changes that affect signal transmission and reception, which leads to performance limitations.

Additionally, attempts have been made to implement low frequency RFID tags in utility markers, wherein the RFID tags can comprise unique identification numbers, marker information and information regarding the utility structure they are buried with. However, typical low frequency RFID readers use a fixed operating frequency (e.g. 125 kHz). The typical reader continuously excites the marker IC to generate the magnetic field and continuously tries to demodulate and process any incoming signals and data. Such systems are suitable for short distance proximity reader purposes that have a signal range (e.g., approx. 1 cm to 10 cm) but cannot support use over longer operating distances (e.g., 1 ft. to 10 ft.) for a plurality of reasons. Furthermore, the fixed operating (excitation) frequency emitted by known locator ICs usually does not match the resonant frequency (e.g., natural, frequency) of the locator IC transmitter nor does it match the resonant frequency (e.g., natural frequency) of the marker IC transponder. Additionally, this frequency mismatch requires the use of low Q antennas in the marker IC and the locator IC. Both the frequency mismatch and the low-quality factor antennas result in decreased operating range.

### SUMMARY

The present disclosure generally provides a buried marker locator and low frequency RFID reader device for locating underground (i.e., buried) markers and reading low frequency RFID tags within the marker at extended distances of 1 ft. to 10 ft. (e.g., 3 ft to 5 ft.). Generally, the locator and low frequency RFID reader device tunes a resonant frequency of a transmit signal of the locator and reader device to the operational resonant frequency of and low frequency RFID tag disposed in the marker to thereby efficiently communicate with the low frequency RFID tag at the extended distances.

More specifically, in various embodiments, the present disclosure generally provides a battery-operated locator and low frequency RFID reader device that incorporates a tunable wideband RFID reader to detect buried (e.g., underground) markers and read low frequency RFID tags disposed within the makers. Generally, via execution of one or more locator and reader operation algorithm by a control unit of the locator and reader device, the locator and low frequency RFID reader device first generates and transmits a wideband excitation signal via a transmit and receive antenna of the locator and low frequency RFID reader device. The frequency range of the wideband signal is large enough to encompass a desired range of buried marker frequencies used to indicate one or more target type of buried structure (e.g., one or more target type of buried utility line and/or structure). Importantly, the wideband excitation signal is sufficient to energize a resonator of any low frequency RFID tag of a target type of buried marker that is located (e.g., buried) within an operational range of the locator and low frequency RFID reader device (for example, within 1 ft. to 10 ft. (e.g., 3 ft to 5 ft.)). The energized marker low frequency RFID tag resonator then generates and transmits a response signal at the resonant frequency of the respective marker low frequency RFID tag resonator. The locator and low frequency RFID reader device receives the response signal via a detection antenna and determines the frequency thereof (e.g., determines the resonant frequency of the of the respective marker low frequency RFID tag resonator). The locator and low frequency RFID reader device then tunes a capacitor bank to the resonant frequency of the respective marker low frequency RFID tag resonator and generates and transmits RFID tag reader signals at the resonant frequency to the low frequency RFID tag, via the transmit and receive antenna. Subsequently, the respective low frequency RFID tag transmits marker communication signals at the resonant frequency of the low frequency RFID tag that are received by the tuned transmit and receive antenna and demodulated (e.g., read) by the locator and low frequency RFID reader device. The marker communication signals comprise various data and information regarding the marker and respective the buried structure.

This summary of various example embodiments of the present disclosure provides a basic understanding of various aspects of the teachings herein. Various embodiments, aspects, and advantages will become apparent from the following detailed description. In addition, the accompanying drawings illustrate, by way of example, the principles of the described embodiments. Accordingly, the description and specific examples set forth herein are intended for purposes of illustration only, and are not intended to limit the scope of the present teachings.

### BRIEF DESCRIPTION OF DRAWINGS

The drawings described herein are for illustration purposes only and are not intended to limit the scope of the present teachings in any way.

FIG. 1 is an exemplary illustration of a battery-operated buried marker locator and low frequency RFID reader device, in accordance with various embodiments of the present disclosure.

FIG. 2 is an exemplary block schematic of battery-operated buried marker locator and low frequency RFID reader device shown in FIG. 1 and an exemplary block schematic of a low frequency RFID marker of the type the battery-operated buried marker locator and low frequency RFID reader device shown in FIG. 1 is used to detect and read, in accordance with various embodiments of the present disclosure.

FIG. 3 is an exemplary flow diagram of the operation of the battery-operated buried marker locator and low frequency RFID reader device shown in FIG. 1, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. It should be understood that the drawings are intended to illustrate and plainly disclose presently envisioned embodiments to one of skill in the art, but are not intended to be manufacturing level drawings or renditions of final products, and may include simplified conceptual views to facilitate understanding or explanation. The relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

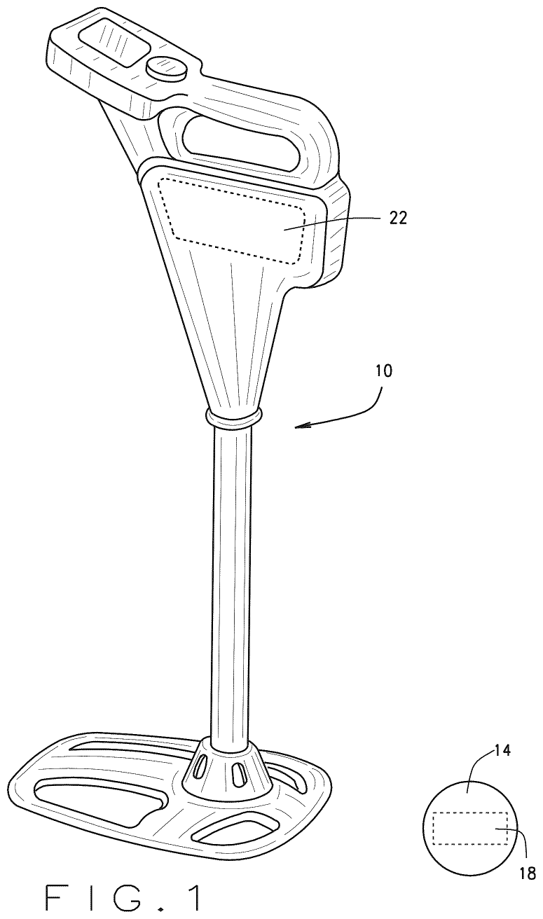

Referring to FIG. 1, in various embodiments the present disclosure provides a battery-operated buried marker locator and low frequency RFID reader device 10 (sometimes referred to herein as simply the locator and reader device 10). The locator and reader device 10 is structured and operable to detect a plurality of different passive low frequency electromagnetic markers 14 that are buried underground at a depth of 1 ft to 10 ft (e.g., 3 ft to 5 ft) in close proximity (e.g., 1 to 12 inches) to an underground structure and then read a passive low frequency RFID tag 18 (e.g., a passive low frequency RFID integrated circuit (IC) 18) of the markers 14 using only the electrical power provided by a battery 22 of the locator and reader device 10 (e.g., a 20-60 volt or greater battery). The underground structures can be any buried structures, for example, structures buried by companies such as telecommunication companies, electrical utility companies, gas companies, water companies, sewer companies. The locator and reader device 10 is structured and operable to detect passive low frequency electromagnetic markers 14 structured to operate at any low frequency range, for example, frequencies between 30 kHz and 300 kHz. Particularly, the passive low frequency electromagnetic markers 14 can comprise a plurality of different markers, wherein various different ones of the markers 14 are structured to operate at various standard low frequencies, whereby certain frequencies are predetermined to be used with and to identify certain buried structures so that the location of specific structures can be easily and readily identified.

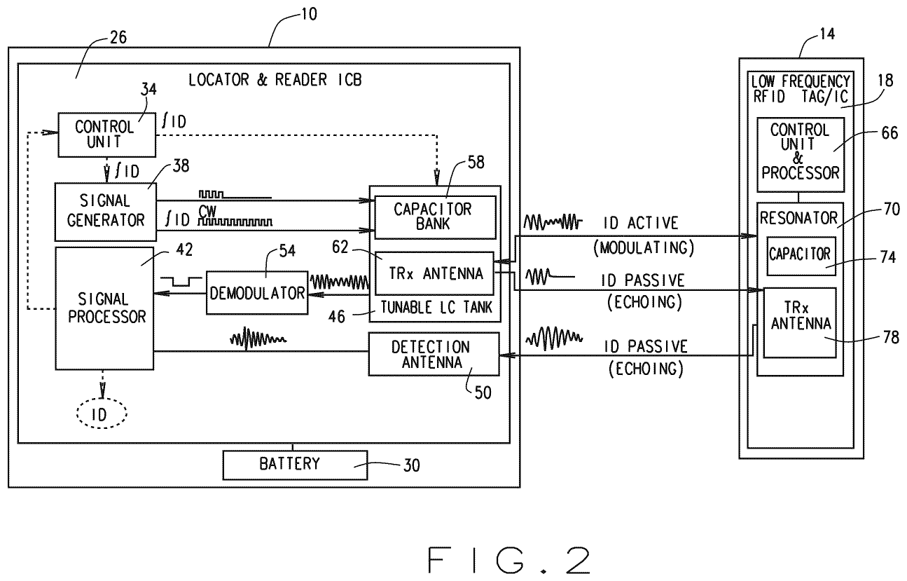

Referring now to FIGS. 1 and 2, the battery-operated buried passive low frequency electromagnetic markers locator and low frequency RFID reader device 10 generally comprises a locator and reader integrated circuit board (ICB) 26 and one or more battery 30 that is electrically connected to the locator and reader ICB 26 to provide electrical power to the locator and reader ICB 26. The battery(ies) 30 can comprise one or more replaceable battery (e.g., one or more Li battery) or one or more rechargeable battery. In various embodiments, the locator and reader ICB 26 can comprise a control unit 34, a signal generator 38 electrically and communicatively connected the control unit 34, a signal processor 42 electrically and communicatively connected to the control unit 34, a tunable tank circuit 46 electrically and communicatively connected to control unit 34, a detection antenna 50 electrically and communicatively connected to the signal processor 42, and a demodulator 54 electrically and communicatively connected between the tunable LC tank circuit 46 and the signal processor 42. In various embodiments the tunable LC tank circuit 46 comprises a capacitor bank 58 electrically and communicatively connected to the signal processor 38, and a transmit and receive antenna 62 that is communicatively connectable to the low frequency RFID tag/IC 18 of a passive low frequency electromagnetic marker 14. s

The control unit 34 is the main processor in the locator and reader ICB 26 and controls all the operations of the locator and reader device 10, particularly of the locator and reader ICB 26, via execution of one or more locator and reader algorithm. The signal generator 38 is an amplifier used for both the RFID reading and the passive low frequency electromagnetic marker detection described below. The tunable LC tank circuit 76 contains the capacitor bank 58 and the transmit and receive antenna 62, wherein the capacitor bank 58 comprises a plurality of different capacitance capacitors that can be selectably grouped together to tune the frequency of electromagnetic signals transmitted by transmit and receive antenna 62 to any specific frequency, e.g., the specific resonant frequency of a resonator 70 of any passive low frequency electromagnetic marker 14 detected by the locator and reader device 10, thereby improving efficiency and output power. as described below. Using the capacitor bank 58, in various embodiments, the tunable LC tank circuit can be continuously tuned between 60 kHz and 180 kHz with a resolution of approximately 0.2%. The transmit and receive antenna 62 is used to transmit wideband (e.g., broadband) excitation signals that power a passive low frequency electromagnetic marker 14, and to also transmit information and data request signals that are tuned to the resonant frequency of the marker resonator 70. The information and data request signals request various buried structure identification information and data from the RFID tag/IC 18 regarding the respective buried structure (e.g., a utility structure) the passive low frequency electromagnetic marker 14 is buried in close proximity to for the purpose identifying the respective structure, such as the type of structure, a pipe number or a cable gauge, or a routing direction or configuration of the respective utility.

The detection antenna 50 is a separate, distinct and independent antenna from the transmit and receive antenna 62. The detection antenna is not tuned and is only used in a passive mode to locate where a passive low frequency electromagnetic marker 14 is underground and to determine the resonant frequency of the marker resonator 70. The demodulator 54 is a circuit that takes a raw signal from the passive low frequency electromagnetic marker 14 and filters out the high frequencies such that only the lower frequency RFID marker information and data is communicated to the signal processor 42 and control unit 34. The signal processor 38 helps perform digital signal processing (DSP) filtering of information and data response signals received from the passive low frequency electromagnetic marker 14.

In various embodiments, the passive low frequency electromagnetic marker 14 comprises generally comprises the low passive frequency RFID integrated circuit (IC) 18 (also referred to as an RFID tag 18) that generally comprises a control unit and processor 66 electrically and communicatively connected to a resonator 70. The resonator 70 generally comprises one or more capacitor 74 and a transmit and receive antenna 78. As described below, the marker resonator 70 is communicatively connectable to the locator and reader device tunable LC tank circuit 46 (more particularly to the tunable LC tank circuit transmit and receive antenna 62), via electromagnetic signals, for location and RFID tag resonant frequency identification operations of the locator and reader device 10. More specifically, when placed in a detection mode, the locator and reader device 10 will locate a passive low frequency electromagnetic marker 14 and determine the resonant frequency of the marker resonator 70 of the respective marker 14 using an echoing protocol wherein the low frequency communication (e.g., 30 kHz and 300 kHz) between the locator and reader device tunable LC tank circuit 46 and the marker resonator 70 is passive in that no RFID tag information and data (e.g., marker information and data) is communicated.

More particularly, a passive low frequency electromagnetic marker 14 is located and the resonant frequency of the marker resonator 70 of the respective marker 14 is determined by placing the locator and reader device 10 in the detection mode whereby the signal processor 42 of the locator and reader ICB 26 will generate and transmit the wideband excitation signals via the transmit and receive antenna 62. The frequency range of the wideband excitation signals is large enough to encompass a known range of buried marker 14 frequencies used to indicate one or more target type of buried structure (e.g., one or more target type of buried utility line and/or structure), referred to herein as target marker(s) 14. That is, in various embodiments, the wideband excitation signals comprise burst signals spanning a frequency range encompassing a plurality of operating frequencies used by a plurality of passive low frequency electromagnetic markers. Importantly, the strength and frequency of the wideband excitation signal is sufficient to energize the resonator 70 of the RFID tag/IC 18 of a target marker 14 that is located (e.g., buried) within an operational range of the locator and low frequency RFID reader device 10 (e.g., within 1 ft. to 10 ft. (e.g., 3 ft to 5 ft.)). When the resonator 70 of a target marker 14 is energized, the marker RFID IC 18 will generate and transmit a passive echo signal at the resonant frequency of the marker resonator 70. The echo signal is received by the detection antennal 50 of the locator and reader ICB 26 whereafter the signal processor 42 and the control unit 34 determine frequency of the echo signal (i.e., determine the resonant frequency of the marker resonator 70.

Thereafter, the locator and reader device 10 can be placed in a read mode whereby the locator and reader ICB control unit 34 tunes or sets the tunable LC tank circuit, via the capacitor bank 58, to generate and transmit information and data requests signals to the marker RFID tag/IC 18 at the resonant frequency of the marker resonator 70, and then receive information and data response signals from the marker RFID tag/IC 18 at the resonant frequency of the marker resonator 70. That is, as described below, the marker resonator 70 is additionally communicatively connectable to the locator and reader device tunable LC tank circuit 46 (more particularly to the tunable LC tank circuit transmit and receive antenna 62), via electromagnetic signals, for communicating RFID tag information (e.g., marker information) from the RFID IC 18 to the locator and reader ICB 26. More specifically, when placed in the read mode, the locator and reader device 10 will request RFID tag information and data (e.g., marker information and data) from the marker RFID tag/IC 18 using a modulating protocol wherein the radio frequency signals sent from by the tunable LC tank circuit 46 to the marker resonator 70 are tuned to the resonant frequency of the marker resonator 70 via the capacitor bank 58. Thereafter, the marker RFID IC 18 will demodulate the tuned signals and reply, sending signals to the tunable LC tank circuit 46 (i.e., to the locator and reader transmit and receive antenna 62) at the resonant frequency of the marker resonator 70, providing the requested RFID tag information. This information request and reply communication, via low frequency signals (e.g., 30 kHz and 300 kHz) tuned to the resonant frequency of the marker resonator 70, is referred to herein as low frequency active communication.

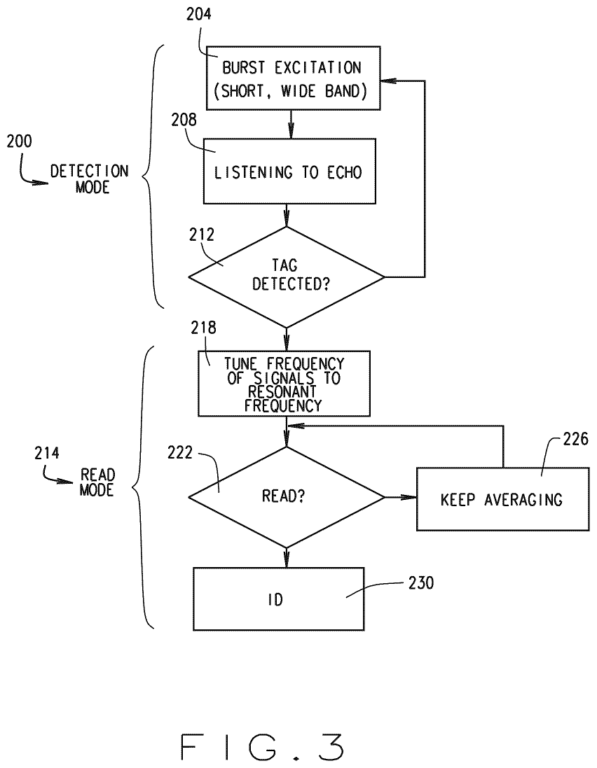

Referring now to FIGS. 1, 2 and 3, as described above, the locator and reader device 10 can be set to a detection mode for locating a passive low frequency electromagnetic marker 14 and determining the resonant frequency of the marker resonator 70, and a read mode for requesting and receiving marker information and data from the RFID tag/IC 18 via signals tuned to the resonant frequency of the marker resonator 70. As illustrated in FIG. 3, using the locator and reader device 10 to locate a marker 14 and read the RFID tag information and data therefrom typically starts by setting the locator and reader device 10 to the detection mode, as indicated at 200. Upon initiation by a user (e.g., pushing a locate button, etc.) the locator and reader device 10 (i.e., the locator and reader ICB 26) begins to transmit burst excitation signals comprising short, wideband (e.g., broadband) signals via the signal generator 38 and capacitor bank 58 and the transmit and receive antenna 62 (e.g., via the tunable LC tank circuit 46), as indicated at 204.

Transmitting wideband burst excitation signals will excite or energize the resonator 70 of any marker RFID tag/IC 18 within the operating range of the locator and reader device 10 (for example, 1 ft to 10 ft, e.g., 3 ft to 5 ft) without activating the RFID tag/IC 18, e.g., without requesting any RFID tag information and data. Consequently, the RFID tag resonator 70 will send a response signal (e.g., an echo signal) that appears to the locator and reader device 10 as a high resistance load on the marker resonator transmit and receive antenna, as indicated at 208. The response of the inactivated RFID tac/IC 18 (e.g., the echo signal) is a decaying sinusoidal signal oscillating at the resonant frequency of the RFID tag resonator 74. The excitation signal is continuously sent until the echo signal is received by the detection antenna 50, as indicated at 212. Note the echo signal is received by the locator and reader detection antenna 50, not by the locator and reader transmit and receive antenna 62. Hence, by sending the short, wideband excitation signals (via the locator and reader device transmit and receive antenna 62) and receiving the echo signal (via the locator and reader device detection antenna 50), the locator and reader ICB 26 (via the demodulator 54 and signal processor 42) detect the presence of the decaying echo signal and measure the frequency of the decaying signal that corresponds to the resonant frequency of the detected marker RFID tag resonator 78. As described above transmitting the wideband excitation signal via the transmit and receive antenna 62 of the locator and reader ICB 26 to energize the resonator 70 of the passive low frequency RFID tag/IC 18 comprises energizing the resonator 70 to produce the echo signal while the passive low frequency RFID tag/IC remains inactive with respect to transmission of RFID tag information and data.

Once the presence of a passive low frequency electromagnetic marker 14 is detected and the resonant frequency of the respective RFID tag resonator 70 is acquired, a user places the locator and reader device 10 in the read mode (e.g., by pushing a read button, etc.), as indicated at 214. Thereafter, (via the control unit 34, the signal processor 42, the signal generator 38 and the tunable LC tank circuit 46) the locator and reader ICB 26 tunes the frequency (e.g., sets the frequency) of RFID information and data request signals (sometimes referred to as read signals) transmitted by the transmit and receive antenna 62 to the measured or determined resonant frequency of the marker resonator 70, as indicated at 218. Particularly, the signal generator 38 tunes (e.g., configures) the capacitor bank 58 such that RFID information and data request signals are transmitted via the transmit and receive antenna 62 at the resonant frequency of the RFID tag resonator 70, as indicated at 222. The RFID information and data request signals energize the marker resonator 70 and request RFID tag information and data, whereafter low frequency (e.g., 30 kHz and 300 kHz) bidirectional RFID active communication is carried out via information and data request signals tuned to the resonant frequency of the marker resonator 70 and information and data response signals at the resonant frequency of the marker resonator 70. Since the detection and resonant frequency identification of the RFID tag/IC 18 always precedes the data read attempt, the RFID information and data request signals are only sent when RFID tag information and data is needed. This results in a more energy efficient operation, as read mode operation consumes less power than typical RFID readers that transmit such information and data request signal continuously. Moreover, since the locator and reader transmit and receive antenna 62 sends information and data request signals tuned to the resonant frequency of the marker resonator 70, the locator and reader transmit and receive antenna 62 is operated very efficiently using less power and allowing the locator and reader device 10 to locate and read the RFID tag/IC information and data of markers buried 1 ft to 10 ft (e.g., 3 ft to 5 ft) deep using only the battery 30 as a power source.

As indicated at 222 and 226, an additional benefit of only sending RFID information and data request signals when RFID tag information and data is needed is that locator and reader device 10 can employ or implement an adaptive averaging technique to accurately obtain or collect the RFID tag information and data (e.g., buried structure identification information and data) provided by the information and data response signals. Particularly, the control unit 34 executes one or more adaptive averaging algorithm that averages multiple inputs of RFID tag information and data provided by the information and data response signals to more accurately determine (e.g., more accurately read) the RFID tag information and data received from the marker RFID tag/IC 18, as indicated at 230. More specifically, the RFID tag information and data transmitted from the marker RFID tag/IC 18 (via the marker resonator transmit and receive antenna 78) and received by the locator and reader device ICB 26 (via the locator and reader transmit and receive antenna 62) can be requested, received and recorded multiple times and then averaged. This adaptive averaging eliminate any noise in the data and allows for more accurate determine (e.g., more accurate reading) the RFID tag information and data received from the marker RFID tag/IC 18 buried in the ground a longer distances (e.g., 1 ft to 10 ft, e.g., 3 ft to 5 ft). During the averaging, the consistency of the received data can be monitored, and averaging can be continued until a given certainty indicator shows that the received data is valid. By implementing the adaptive averaging technique, the low frequency (e.g., 30 kHz and 300 kHz) bidirectional RFID active communication range (e.g., distance) of the reader system/device of the present disclosure can be highly extended (for example 1 ft to 10 ft, e.g., 3 ft to 5 ft), while energy efficiency is increased, because the read sequence takes only as much time as needed to accurately acquire the data.

In various embodiments, during the bidirectional RFID active communication adaptive averaging loop, the locator and reader ICB 26 (via the demodulator 54, the signal processor 42 and the control unit 34) can determine the phase of the information and data response signals via a phase detector module of the signal processor 42. The control unit 34 can then generate the information and data request signals to be in phase with the information and data response signals once the tunable LC tank circuit 46 is tuned as described above. Particularly, value and sign of the phase difference between the information and data request signals and the information and data response signals gives precise information about the tuning needs of the tunable LC tank circuit 46 making the tuning process fast and accurate.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A battery-operated buried marker locator and low frequency RFID reader device, said device comprising:
a locator and reader integrated circuit (IC); and
at least one battery electrically connected to the locator and reader IC to provide power to the locator and reader IC, wherein the locator and reader IC comprises;
a tunable LC tank circuit electrically and communicatively connected to the control unit and to the signal generator, the tunable LC tank circuit comprising:
a capacitor bank; and
a transmit and receive antenna electrically connected to the capacitor bank; and
a detection antenna that is separate and distinct from the transmit-and-receive antenna and electrically and communicatively connected to the signal processor,
wherein the locator and reader IC is structured and operable to:
transmit a wideband excitation signal via the transmit and receive antenna to energize a resonator of a passive low frequency RFID tag of a buried marker;
receive, via the detection antenna, an echo signal from the passive low frequency RFID tag in response to the wideband excitation signal;
determine a resonant frequency of a marker resonator of the low frequency RFID tag via the echo signal; and
transmit, via the transmit and receive antenna, a plurality of RFID information and data request signals to the passive low frequency RFID tag, wherein the RFID information and data request signals are tuned to the resonant frequency of the marker resonator.

2. The device of claim 1, wherein the locator and reader IC is further structured and operable to receive, via the transmit and receive antenna, a plurality of information and data response signals from the passive low frequency RFID tag in response to the plurality of RFID information and data request signals, wherein the information and data response signals comprise RFID tag information and data.

3. The device of claim 2, wherein the locator and reader IC is further structured and operable to:
determine a phase of the information and data response signals; and
generate the tuned information and data request signals to be in phase with the information and data response signals.

4. The device of claim 2, wherein the locator and reader IC is further structured and operable to execute one or more adaptive averaging algorithm that averages multiple inputs of RFID tag information and data provided by the information and data response signals to more accurately determine the RFID tag information and data received from the passive low frequency RFID tag.

5. The device of claim 4, wherein the device is configurable in:
a detection mode to transmit the wideband excitation signal via the transmit and receive antenna, and to receive the echo signal via the detection antenna; and
a read mode to transmit the information and data request signals and receive the information and data response signals via the transmit and receive antenna.

6. The device of claim 1, wherein the wideband excitation signals comprise burst signals spanning a frequency range encompassing a plurality of operating frequencies of a plurality of different markers.

7. The device of claim 1, wherein the locator and reader IC is further structured and operable to energize the resonator of the passive low frequency RFID tag, via the wideband excitation signal via the transmit and receive antenna, to produce the echo signal while the passive low frequency RFID tag remains inactive with respect to data transmission.

8. A method of locating a passive low frequency buried marker and reading data from a passive low frequency RFID tag of the buried marker, said method comprising:
powering a locator and reader integrated circuit (IC) of a buried marker locator and low frequency RFID reader device using a battery;
transmitting a wideband excitation signal via a transmit and receive antenna of the locator and reader IC to energize a resonator of a passive low frequency RFID tag of a buried marker;
receiving, via a detection antenna of the locator and reader IC, an echo signal from the passive low frequency RFID tag in response to the wideband excitation signal;
determining a resonant frequency of a marker resonator of the low frequency RFID tag via the echo signal; and
transmitting, via the transmit and receive antenna, a plurality of RFID information and data request signals to the passive low frequency RFID tag, wherein the RFID information and data request signals are tuned to the resonant frequency of the marker resonator utilizing a capacitor bank electrically connected to the transmit receive antenna.

9. The method of claim 8, further comprising receiving, via the transmit and receive antenna, a plurality of information and data response signals from the passive low frequency RFID tag in response to the plurality of RFID information and data request signals, wherein the information and data response signals comprise RFID tag information and data.

10. The method of claim 9, further comprising:
determining a phase of the information and data response signals; and
generating the tuned information and data request signals to be in phase with the information and data response signals.

11. The method of claim 9, further comprising adaptive averaging multiple inputs of RFID tag information and data provided by the information and data response signals, via execution of one or more adaptive averaging algorithm, to more accurately determine the RFID tag information and data received from the passive low frequency RFID tag.

12. The method of claim 10, further comprising:
configuring the locator and reader IC in a detection mode to transmit the wideband excitation signal via the transmit and receive antenna, and to receive the echo signal via the detection antenna; and
configuring the locator and reader IC in a read mode to transmit the information and data request signals and receive the information and data response signals via the transmit and receive antenna.

13. The method of claim 8, wherein transmitting a wideband excitation signal via a transmit and receive antenna comprises transmitting burst signals spanning a frequency range encompassing a plurality of operating frequencies of a plurality of different markers.

14. The method of claim 8, wherein transmitting the wideband excitation signal via the transmit and receive antenna of the locator and reader IC to energize the resonator of the passive low frequency RFID tag of the buried marker comprises energizing the resonator of the passive low frequency RFID tag to produce the echo signal while the passive low frequency RFID tag remains inactive with respect to data transmission.
